(19) United States
(12) Patent Application Publication
(10) Pub. No.: US 2014/0176481 A1
(43) Pub. Date: Jun. 26, 2014

(54) Capacitive Touch Screen

(71) Applicant: GAN ZHOU. DPT-TECHNOLOGY CO., LTD., Ganzhou City (CN)

(72) Inventors: Hengjun ZHANG, Ganzhou City (CN); Aijun LIANG, Ganzhou City (CN); Lingping TANG, Ganzhou City (CN)

(73) Assignee: GAN ZHOU. DPT-TECHNOLOGY CO., LTD., Ganzhou City (CN)

(21) Appl. No.: 13/727,574

(22) Filed: Dec. 26, 2012

(51) Int. Cl. G06F 3/044

(52) U.S. Cl. CPC G06F 3/044
USPC 345/174

(57) ABSTRACT

This invention discloses a capacitive touch screen comprising an Indium Tin Oxide (ITO) tempered glass and an ITO film both of which are adhesively laminated integrally together via an optical adhesive. The ITO tempered glass comprises a glass substrate comprising a viewing window area and a non-viewing window area, a black ink layer disposed on a first lateral surface of the glass substrate and printed in a corresponding area thereof to the non-viewing window area, an ITO circuit plating layer covering the black ink layer and the viewing window area. The present invention utilizes the optical adhesive to directly adhesively laminate the ITO tempered glass and the ITO film, and as a result, its lamination structure is able to simplify. Furthermore, the present invention not only effectively reduces its integral thickness thereof, but also has simple production techniques, a low cost of manufacturing, and a high yield rate of production.

### TECHNICAL FIELD

The present invention relates to a technical field of touch screens, and especially to a capacitive touch screen.

### DESCRIPTION OF BACKGROUND

Currently there are greatly various touch screens in the market, such as, conventional Cover Glass-Induction Glass (GG) structure, Polyethylene Terephthalate-Glass (PET-Glass, PG) structure, Cover Glass-Induction Film-Induction Film (GFF) structure, and One Glass Solution (OGS) structure, etc.

When actually being in manufacturing and using processes of capacitive touch screens, it is found that conventional GG structure capacitive touch screens need double layers of glasses to be formed, and adhesive lamination of two-layer hard glasses may cause both of a lower yield rate and lower efficiency, and such touch screens also cause a higher cost manufacturing and have a larger thickness for final products. Besides, a Polyethylene Terephthalate (PET) film is attached onto a surface of PG structure touch screens, and as a result, the PG structure touch screens have lower surface hardness, and are prone to be scratched and have a larger structural restriction to make. GFF structure touch screens need two layers of Indium Tin Oxide (ITO) films and further need to proceed two adhesive lamination steps. Therefore, making of GFF structure touch screens results in both of higher costs of material and manufacturing, and have both of a lower yield rate and efficiency. Besides, fixture of a flexible circuit board for GFF structure touch screens also has functional drawbacks. In addition, since yellow-light lithography processes are required and bridging technique is adopted in making OGS structure touch screens, such making technology causes a higher cost of manufacturing to achieve better efficiency.

### SUMMARY

An object of the present invention to solve the existing technical drawbacks is to provide a capacitive touch screen which has simple structure, higher productive efficiency, and a lower manufacturing cost.

To achieve the above objects to solve the above drawbacks, the present invention provides technical solutions of a capacitive touch screen comprising an Indium Tin Oxide (ITO) tempered glass and an ITO film both of which are adhesively laminated integrally together via an optical adhesive.

Furthermore, the ITO tempered glass comprises a glass substrate comprising a viewing window area and a non-viewing window area, a black ink layer disposed on a first lateral surface of the glass substrate and printed in a corresponding area thereof to the non-viewing window area, an ITO circuit plating layer covering the black ink layer and the viewing window area, and a metal circuit layer formed by adopting yellow light lithography processes and attached to an outer surface of the ITO circuit plating layer.

Furthermore, the ITO film comprises a substrate layer, an ITO layer formed at a side surface of the substrate layer, and a conductive silver paste layer covering outside the ITO layer. An outer surface of the metal circuit layer of the ITO tempered glass and the conductive silver paste layer of the ITO film are adhesively laminated by the optical adhesive.

Furthermore, an ITO tempered glass comprises a glass substrate comprising a viewing window area and a non-viewing window area, a first black ink layer disposed on a first lateral surface of the glass substrate and printed in a corresponding area thereof to the non-viewing window area, an ITO circuit plating layer plated in a corresponding area of the glass substrate to the viewing window area, a conductive silver paste layer covering outside the first black ink layer and connecting with the ITO circuit plating layer via a conduction block, and a second black ink layer covering outside the conductive silver paste layer.

Furthermore, an ITO film comprises a substrate layer, an ITO layer formed at a side surface of the substrate layer, and a conductive silver paste layer covering outside the ITO layer. An outer surface of the second black ink layer of ITO tempered glass and the conductive silver paste layer of the ITO film are adhesively laminated via the optical adhesive.

After adopting the above-mentioned technical solutions, the present invention at least has following beneficial advantages. First, the present invention utilizes the optical adhesive to directly adhesively laminate the ITO tempered glass and the ITO film, and as a result, its lamination structure is able to simplify. Furthermore, the present invention not only effectively reduces its integral thickness thereof, but also has simple production techniques, a low cost of manufacturing, and a high yield rate of production. In addition, thickness of capacitive touches screens in accordance with the present invention is smaller than the existing GG structure and GFF structure touch screens. Although the thickness of capacitive touch screens in accordance with the present invention is slightly larger than the existing OGS structure touch screens, the capacitive touch screens in accordance with the present invention perform better.

### DESCRIPTION OF THE DRAWINGS

FIG. 1 is a structurally schematic cross-sectional view of a capacitive touch screen in accordance with an embodiment of the present invention.

FIG. 2 is a structurally schematic cross-sectional view of a capacitive touch screen in accordance with another embodiment of the present invention.

### DETAILED DESCRIPTION OF THE EMBODIMENTS

It is required to explain that, without any confliction, embodiments of the present invention and features thereof can be combined, and are further described in detail in cooperation with drawings and physical examples as follows.

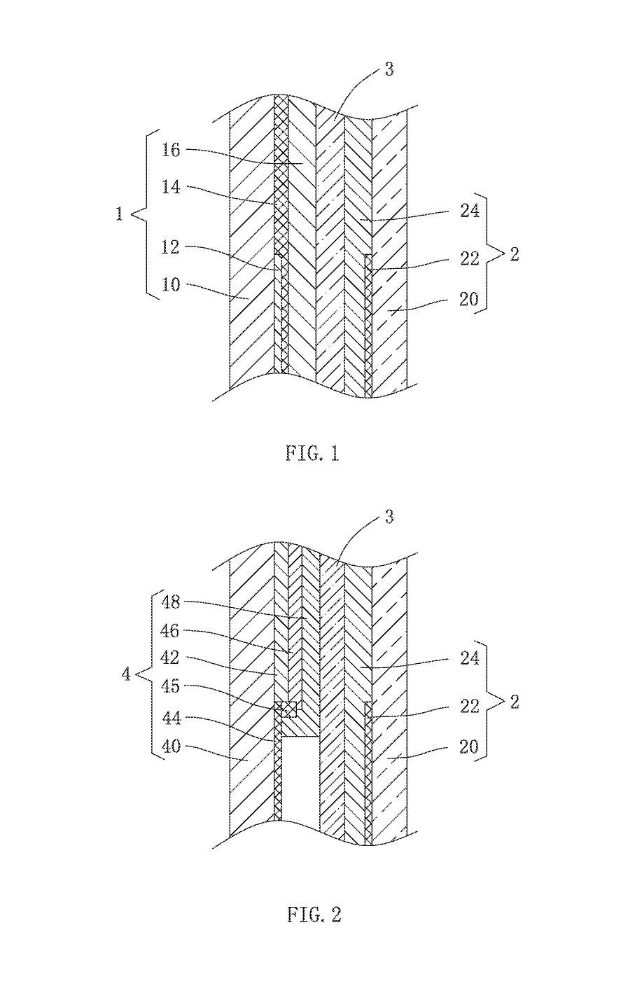

As shown in FIG. 1, a capacitive touch screen is provided in accordance with an embodiment of the present invention. The capacitive touch screen comprises an Indium Tin Oxide (ITO) tempered glass 1 and an ITO film 2 both of which are adhesively laminated integrally together via an optical adhesive 3.

The ITO tempered glass 1 comprises a glass substrate 10. The glass substrate 10 has a viewing window area and a non-viewing window area. A black ink layer 12 is disposed on a first lateral surface of the glass substrate 10 and is printed in a corresponding area thereof to the non-viewing window area. An ITO circuit plating layer 14 is disposed to cover the black ink layer 12 and the viewing window area. A metal circuit layer 16 formed by adopting yellow-light lithography processes is further disposed to an outer surface of the ITO circuit plating layer 14. In addition, the metal circuit layer 16 is distributed in separated linear strip arrangement rather than entirely covering the ITO circuit plating layer 14.

The ITO film 2 comprises a substrate layer 20, an ITO layer 22 formed at a side surface of the substrate layer 20, and a conductive sliver paste layer 24 covering at an outside of the ITO layer 22.

When proceeding adhesive lamination for this present embodiment, outer surfaces of the ITO circuit plating layer 14 and the metal circuit layer 16 of the ITO tempered glass 1 and the silver conductive paste layer 24 of the ITO film 2 are adhesively laminated via the optical adhesive 3.

The production processes of the capacitive touch screen in accordance with this present embodiment as shown in FIG. 1 comprise the following:

Step 1: the black ink layer 12 is printed at the corresponding area to the non-viewing window area of the first lateral surface of the glass substrate 10;

Step 2: the ITO circuit plating layer 14 is plated on the entire face of the glass substrate 10 outside the black ink layer 12, and the ITO circuit plating layer 14 entirely covers the black ink layer 12 and the viewing window area;

Step 3: the metal circuit layer 16 is plated on the ITO circuit plating layer 14 via yellow-light lithography processes so as to acquire the ITO tempered glass 1;

Step 4: a back protective glue is printed on the substrate layer 20 of the ITO film 2, and then proceeds a process of pre-dehydration;

Step 5: an acid-duration ink is printed on the substrate layer 20, and the substrate layer 20 is then etched so as to form the ITO layer 22 with a preset ITO pattern;

Step 6: the conductive silver paste layer 24 is further printed on the ITO layer 22 so as to acquire the ITO film 2;

Step 7: the optical adhesive 3 is adhered onto the ITO films 2, and the ITO film 2 and the ITO tempered glass 1 are adhesively laminated together;

Step 8: a flexible circuit board (FPC) is pressed and attached onto circuits of the ITO film 2 and the ITO tempered glass 1, and final products will be ready for shipment after passing quality tests.

As shown in FIG. 2, another embodiment of the present invention shows an ITO tempered glass 4 with a different structural form is used and replaces the ITO tempered glass 1 of the embodiment as shown in FIG. 1. The structure of the ITO film 2 in this another embodiment is the same as the ITO film 2 of the embodiment as shown in FIG. 1. In this another embodiment, the ITO tempered glass 4 comprises a glass substrate 40 which has a viewing window area and a non-viewing window area. A first black ink layer 42 is disposed on a first lateral surface of the glass substrate 40 and is printed in a corresponding area thereof to the non-viewing window area. An ITO circuit plating layer 44 is plated in a corresponding area of the viewing window area. A conductive silver paste layer 46 covers outside the first black ink layer 42 and is connected with the ITO circuit plating layer 44 via a conduction block 45, and a second black ink layer 48 covers outside the conductive silver paste layer 46. When proceeding the process of adhesive lamination for this another embodiment, an outer surface of the second black ink layer 48 of the ITO tempered glass 4 and the conductive silver paste layer 24 of the ITO film 2 are adhesively laminated together via the optical adhesive 3.

The production processes of the capacitive touch screen in accordance with this another embodiment as shown in FIG. 2 comprise the following:

Step 1: the ITO circuit plating layer 44 is plated onto a corresponding area to the viewing window area of the first lateral surface of the glass substrate 40;

Step 2: the first black ink layer 42 is printed in the corresponding area to the non-viewing window area of the first lateral surface of the glass substrate 40;

Step 3: the conduction block 45 is printed at a location of the ITO circuit plating layer 44 adjacent to the first black ink layer 42;

Step 4: the conductive silver paste layer 46 is printed outside the first black ink layer 42;

Step 5: the second black ink layer 48 is printed outside the conductive silver paste layer 46;

Step 6: a back protective film is printed on the substrate layer 20 of the ITO film 2, and then a pre-dehydration process is proceeded;

Step 7: an acid-duration ink is printed on the substrate layer 20, and the substrate layer 20 is then etched so as to form the ITO layer 22 with a preset ITO pattern;

Step 8: the conductive silver paste layer 24 is printed on the ITO layer 22;

Step 9: the optical adhesive 3 is adhered on the ITO films 2, and the ITO film 2 and the ITO tempered glass 4 are adhesively laminated together;

Step 10: a flexible circuit board (FPC) is pressed and attached onto circuits of the ITO film 2 and the ITO tempered glass 4, and final products will be ready for shipment after passing quality tests.

Despite disclosures and descriptions of exemplary embodiments of the present invention. It should be understood, for persons of ordinary skills in this and related art fields, improvements, modifications, replacements and changes within the spirit of the present invention can be further made, and such improvements, modifications, replacements and changes should be included in the claimed scope of the present invention as defined below.

What is claimed is:

1. A capacitive touch screen, comprising an Indium Tin Oxide (ITO) tempered glass and an ITO film both of which are adhesively laminated integrally together by an optical adhesive.

2. The capacitive touch screen as claimed in claim 1, wherein the ITO tempered glass comprises a glass substrate comprising a viewing window area and a non-viewing window area, a black ink layer disposed on a first lateral surface of the glass substrate and printed in a corresponding area thereof to the non-viewing window area, an ITO circuit plating layer covering the black ink layer and the viewing window area, and a metal circuit layer formed by adopting yellow light lithography processes and attached to an outer surface of the ITO circuit plating layer.

3. The capacitive touch screen as claimed in claim 2, wherein the ITO film comprises a substrate layer, an ITO layer formed at a side surface of the substrate layer, and a conductive silver paste layer covering outside the ITO layer, outer surfaces of the ITO circuit plating layer and the metal circuit layer of the ITO tempered glass and the conductive silver paste layer of the ITO film are adhesively laminated by the optical adhesive.

4. The capacitive touch screen as claimed in claim 1, wherein an ITO tempered glass comprises a glass substrate comprising a viewing window area and a non-viewing window area, a first black ink layer disposed on a first lateral surface of the glass substrate and printed in a corresponding area thereof to the non-viewing window area, an ITO circuit plating layer plated in a corresponding area of the glass substrate to the viewing window area, a conductive silver paste layer covering outside the first black ink layer and connecting with the ITO circuit plating layer via a conduction block, and a second black ink layer covering outside the conductive silver paste layer.

5. The capacitive touch screen as claimed in claim 4, wherein an ITO film comprises a substrate layer, an ITO layer formed at a side surface of the substrate layer, and a conductive silver paste layer covering outside the ITO layer, an outer surface of the second black ink layer of ITO tempered glass and the conductive silver paste layer of the ITO film are adhesively laminated via the optical adhesive.
